(19) United States
(12) Patent Application Publication
(10) Pub. No.: US 2025/0002163 A1
(43) Pub. Date: Jan. 2, 2025

(54) FLYING OBJECT PROVIDED WITH SAFETY DEVICE

(71) Applicant: AERONEXT INC., Tokyo (JP)

(72) Inventor: Yoichi SUZUKI, Tokyo (JP)

(21) Appl. No.: 18/711,461

(22) PCT Filed: Nov. 18, 2021
(86) PCT No.: PCT/JP2021/042434

§ 371 Date: May 17, 2024

(51) Int. Cl. B64D 17/54; B64U 10/16; B64U 20/30; B64U 101/64

(52) U.S. Cl. CPC B64D 17/54; B64U 10/16; B64U 20/30; B64U 2101/64

(57) ABSTRACT

The flying object of this disclosure is a flying object provided with a safety device that attenuates the fall velocity, wherein the safety device is mounted at an angle that decreases the drag force when traveling than when landing or hovering. Also, the safety device has a reduced frontal projected area when traveling than when landing or hovering.

### TECHNICAL FIELD

This invention relates to a flying object provided with a safety device.

### BACKGROUND ART

In recent years, various services using flying objects such as drones and unmanned aerial vehicles (UAVs) (hereinafter collectively referred to as “flying objects”) have been put to practical use. Flying objects equipped with multiple propellers (hereinafter collectively called “multicopters”), commonly called “multicopters,” do not require a runway for takeoff and landing like ordinary fixed-wing aircraft, and thus can operate in relatively small areas and are suitable for providing services such as home delivery, surveillance, rescue, and the like.

In order to provide various services, flying objects may fly over structures such as buildings and utility poles, or over locations where there may be third parties moving objects on the ground. Usually, flying objects fly over defined navigation routes and altitudes and do not cause damage to surrounding structures or people.

However, when it becomes impossible to continue the flight due to a serious malfunction or unexpected external factors, it becomes difficult to maintain the prescribed route and altitude, and may come into contact with structures or people. In particular, in the event of a crash, depending on the weight and size of the flying object, the damage caused to surrounding people and objects can be significant. To reduce damage, it is necessary to slow down the fall speed of flying objects.

In Patent Literature 1, a parachute that can be mounted on a flying object and a flying object equipped with a parachute are disclosed (see, for example, Patent Literature 1).

### PRIOR ART LIST

### Patent Literature

[Patent Literature 1] WO2021-053670

### SUMMARY OF THE INVENTION

### Technical Problem

Patent Literature 1 discloses a flying object equipped with a parachute that can be quickly deployed in the event of an unexpected failure of the flying object.

The flying object disclosed in Patent Literature 1 is equipped with a parachute that can be deployed in the sky, and the parachute can be operated by remote control or by autonomous control. This can improve the safety of the flying object's operation by slowing down the speed of its fall and reducing damage to surrounding structures and people.

When providing services using flying objects (e.g., delivery, surveillance, etc.), it is necessary not only to improve safety, but also to improve the cruising time and flight speed. Therefore, it is desirable to mount a parachute to reduce damage to the surroundings caused by flying objects crashing, and to prevent the deterioration of flight efficiency.

However, the conventional technology does not consider the deterioration of flight efficiency, and the installation of a safety device increases the drag force and motor load during the movement of a flying object compared to a flying object without a safety device, which may be a factor leading to a significant deterioration of flight efficiency, such as fuel consumption and flight speed.

In view of such a situation, one object of the flying object according to the invention is to provide a flying object capable of suppressing the decrease in flight efficiency during cruising of the flying object while improving the flying object safety.

### Technical Solution

According to the invention, it is possible to provide a flying object provided with a safety device that attenuates the fall velocity, wherein the safety device is mounted at an angle at which the drag force is reduced during traveling rather than during landing or hovering.

Other problems disclosed in this application and their solutions will be clarified in the “Embodiments of the Invention” section and in the drawings.

### Advantageous Effects

According to this invention, it is possible to provide a flying object that can prevent a reduction in flight efficiency while improving the safety of the flying object.

### BRIEF DESCRIPTION OF THE DRAWINGS

FIG. 1 shows a schematic diagram of a flying object according to the invention, viewed from the side.

FIG. 2 shows the flying object of FIG. 1 in cruising attitude.

FIG. 3 shows a top view of the flying object of FIG. 1.

FIG. 4 shows a front view of the flying object of FIG. 1.

FIG. 5 shows a front view of the flying object of FIG. 2.

FIG. 6 shows a functional block diagram of the flying object of FIG. 1.

FIG. 7 shows a parachute deployed by a safety device.

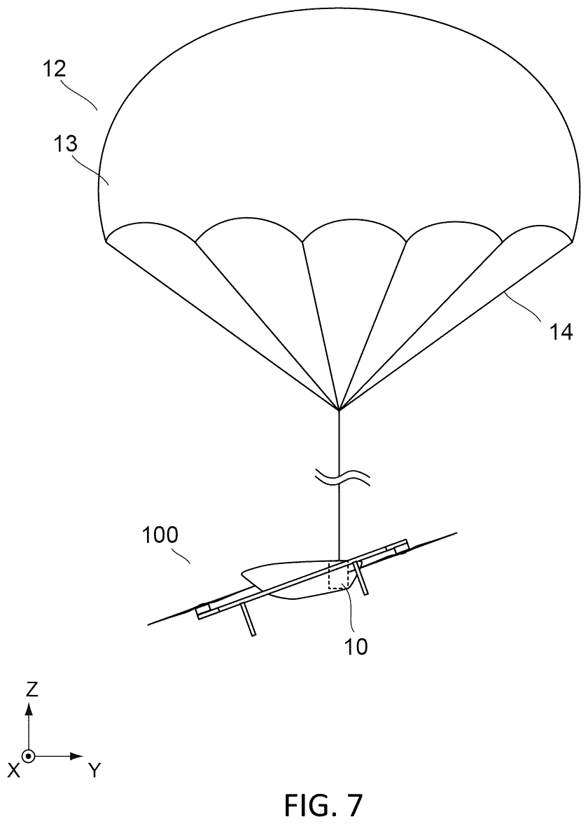

FIG. 8 is a schematic diagram of a flying object viewed from the side using a conventional safety device mounting method.

FIG. 9 shows the flying object of FIG. 8 in cruising attitude.

FIG. 10 shows a top view of the flying object of FIG. 8.

FIG. 11 shows a front view of the flying object of FIG. 8.

FIG. 12 shows a front view of the flying object of FIG. 9.

FIG. 13 shows a schematic view of the flying object with a safety device mounting method according to the invention, viewed from the top.

FIG. 14 shows a side view of the flying object of FIG. 13.

FIG. 15 shows a front view of the flying object of FIG. 13.

FIG. 16 shows a schematic diagram of a flying object viewed from the top, using the conventional safety device mounting method.

FIG. 17 shows a side view of the flying object shown in FIG. 16.

FIG. 18 shows a schematic diagram of the flying object viewed from the top, using the conventional safety device mounting method.

FIG. 19 shows a side view of the flying object of FIG. 18.

FIG. 20 shows a schematic view from the top of another flying object using the safety device mounting method according to the invention.

FIG. 21 shows a side view of the flying object of FIG. 20.

FIG. 22 shows a front view of the flying object shown in FIG. 20.

FIG. 23 shows an enlarged view of the safety device of the flying object.

FIG. 24 shows a partially enlarged view of the safety device of the flying object of FIG. 23 when the parachute is ejected.

The following is a list and description of the contents of this embodiment of the invention. A flying object provided with a safety device according to this embodiment of the invention has the following configuration.

### [Item 1]

A flying object provided with a safety device that attenuates the fall speed,
wherein the safety device is mounted at an angle at which the drag force is reduced when in traveling state rather than when in landing or hovering state.

### [Item 2]

The flying object according to item 1,
wherein the safety device has a reduced frontal projected area when in traveling state than when in landing or hovering state.

### [Item 3]

The flying object as in item 1 or item 2,
wherein, in the landing or hovering state, the centerline of the safety device is inclined toward the rear of the flying object.

### [Item 4]

The flying object according to item 3,
wherein the inclination angle of the centerline of the safety device is the same or similar in magnitude to the angle of forward inclination of the airframe when the flying object is in cruise attitude.

### [Item 5]

The flying object as in any one of item 1 to item 4,
wherein the safety device contains a parachute within the safety device.

### [Item 6]

The flying object as in any one of item 1 to item 5,
wherein, in the landing or hovering state, the center of the safety device is rearward of the center of the flying object.

### [Item 7]

The flying object as in any one of item 1 to item 5,
wherein, in the landing or hovering state, the center of the safety device is forward of the center of the flying object.

### [Item 8]

The flying object as in any one of item 1 to item 5,
wherein, in the landing or hovering state, the center of the safety device is lateral to the center of the flying object.

### [Item 9]

The flying object as in any one of item 1 to item 8,
wherein the safety device is at least partially covered by a cover provided by the flying object.

### [Item 10]

The flying object according to item 9, wherein the cover has a portion that is opened or detached when the safety device is deployed.

### [Item 11]

A safety device mounted on a flying object to attenuate the fall velocity of the flying object,
wherein the safety device is mounted at an angle at which the drag force is reduced with respect to the flying object in a traveling state rather than in a landing or hovering state.

### Details of Embodiments According to this Embodiment

The flying object provided with a safety device according to this embodiment of the invention will be described below with reference to the drawings.

### Details of the First Embodiment

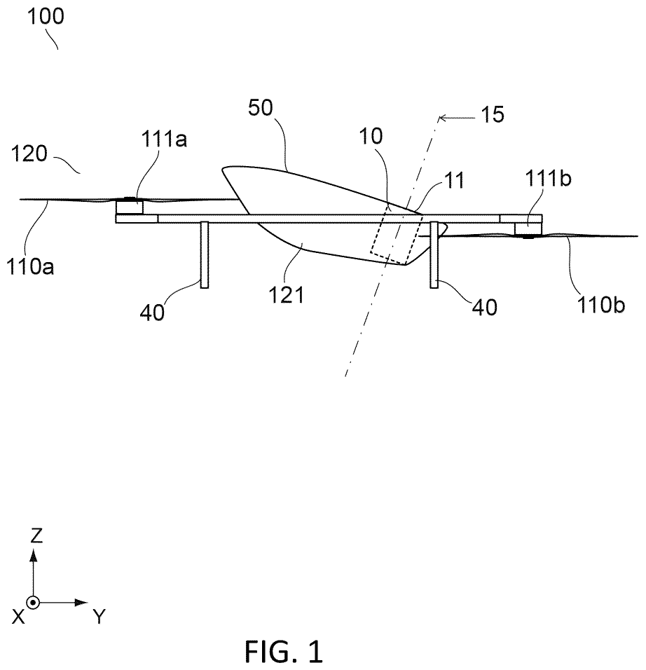

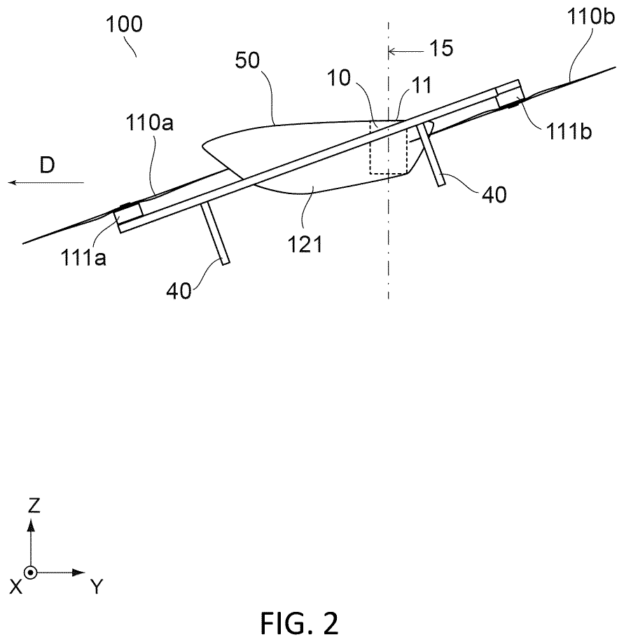

As illustrated in FIG. 1 and FIG. 2, flying object 100 is a flying object that can take off, land, and fly with at least a safety device 10 connected. At least one or more safety devices 10 are connected to the flying object.

The flying object 100 takes off from a takeoff point and flies to a destination. For example, when the flying object makes a delivery, the flying object reaches the destination, lands at or hovers over a port, etc., and completes the delivery by detaching the load. After detaching the load, the flying object moves to other destinations.

As shown in FIG. 1 and FIG. 2, the flying object 100 according to this embodiment is provided with a flight part including a plurality of rotor blade parts comprising at least a propeller 110 and a motor 111, a motor mount supporting said rotor blade parts, a frame 120, and other elements to perform flight. In addition, it should be provided with energy (e.g., rechargeable batteries, fuel cells, fossil fuels, etc.) to operate them.

The flying object 100 shown in the figure is depicted in a simplified form to facilitate the description of the structure of the invention, and the detailed components such as a control part, for example, are not shown in the figure.

The flying object 100 is moving forward in the direction of arrow D (−Y direction) in figures (see below for details).

In the following explanation, terms may be used differently according to the following definitions. Forward/backward: +Y and −Y directions, up/down (or vertical): +Z and −Z directions, left/right (or horizontal): +X and −X directions, forward direction (forward): −Y direction, rearward direction (backward): +Y direction, ascending direction (upward): +Z direction, descending direction (downward): −Z direction.

The propeller 110 rotates by receiving output from the motor 111. The rotation of the propeller 110 generates propulsive force to take the flying object 100 off from the starting point, move it, and land it at the destination. The propeller 110 can rotate to the right, stop, and rotate to the left.

The propeller 110 provided by the flying object of the invention has one or more blades. Any number of blades (rotors) (e.g., 1, 2, 3, 4, or more blades) is acceptable. The shape of the blades can be any shape, such as flat, curved, kinked, tapered, or a combination thereof. The shape of the blades can be changeable (e.g., stretched, folded, bent, etc.). The blades can be symmetrical (having identical upper and lower surfaces) or asymmetrical (having differently shaped upper and lower surfaces). The blades can be formed into airfoils, wings, or any geometry suitable for generating dynamic aerodynamic forces (e.g., lift, thrust) as the blades are moved through the air. The geometry of the vane/wing can be selected as appropriate to optimize the dynamic aerodynamic characteristics of the vane, such as increasing lift and thrust and reducing drag.

The propeller provided by the flying object 100 of the invention can be, but is not limited to, fixed pitch, variable pitch, and also a mixture of fixed and variable pitch.

The motor 111 produces rotation of the propeller 110, for example, the drive unit can include an electric motor or engine. The blades can be driven by the motor and rotate around the axis of rotation of the motor (e.g., the long axis of the motor).

The blades can all rotate in the same direction or can rotate independently. Some of the blades rotate in one direction while others rotate in the other direction. The blades can all rotate at the same RPM, or they can each rotate at a different RPM. The number of rotations can be determined automatically or manually based on the dimensions of the moving object (e.g., size, weight) and control conditions (speed, direction of movement, etc.).

The flying object 100 determines the number of revolutions of each motor and the angle of flight according to the wind speed and direction by means of the flight controller 1001, ESC 112, transceiver (propo/radio) 1006, etc. This allows the flying object to perform movements such as ascending and descending, accelerating and decelerating, and changing direction.

The flying object 100 can fly autonomously according to routes and rules set in advance or during the flight, or by using the transceiver (propo/radio) 1006 to control the flying object.

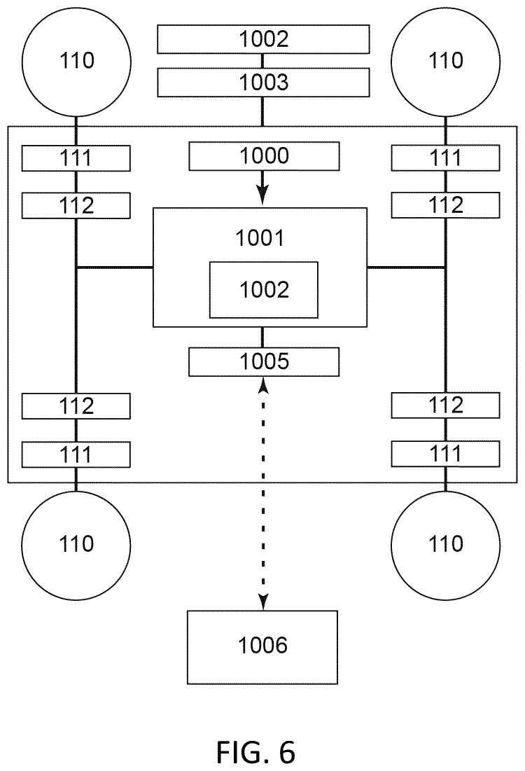

The flying object 100 described above has the functional blocks shown in FIG. 6. The functional block in FIG. 6 is an example of a minimum reference configuration. The flight controller 1001 is a so-called processing unit. The processing unit can have one or more processors, such as a programmable processor (e.g., a central processing unit (CPU)). The processing unit has a memory, not shown, which is accessible. The memory stores logic, code, and/or program instructions that can be executed by the processing unit to perform one or more steps. The memory may include, for example, a separable medium such as an SD card or random access memory (RAM) or an external storage device. Data acquired from sensors 1002 may be directly transmitted to and stored in the memory. For example, still and moving image data captured by a camera or other device is recorded in the internal or external memory.

The processing unit includes a control module comprised to control the state of the rotorcraft. For example, the control module controls the propulsion mechanism (e.g., motor) of the rotorcraft to adjust the spatial arrangement, speed, and/or acceleration of the rotorcraft with six degrees of freedom (translational motion x, y and z, and rotational motion θx, θy and θz). The control module can control one or more of the states of the loading part, sensors, etc.

The processing unit can communicate with a transmission/reception unit 1005, which is configured to transmit and/or receive data from one or more external devices (e.g., terminals, display units, or other remote controllers). The transmitter/receiver 1006 can use any suitable means of communication, such as wired or wireless communication. For example, the transmission/reception unit 1005 can use one or more of local area network (LAN), wide area network (WAN), infrared, wireless. WiFi, point-to-point (P2P) network, telecommunication network, cloud communication, etc. The transmission/reception unit 1005 can transmit and/or receive one or more of the following: data acquired by the sensors 1002, processing results generated by the processing unit, predetermined control data, and user commands from a terminal or remote controller.

Sensors 1002 in this embodiment can include an inertial sensor (accelerometers, gyroscopes), a GPS sensor, a proximity sensor (e.g., lidar), or a vision/image sensor (e.g., cameras).

The plane of rotation of the propeller 110 provided by the flying object 100 in this embodiment is at a forward inclined angle facing the direction of travel when traveling. The forward inclined rotating surface of the propeller 110 creates an upward lift force and a thrust force in the direction of travel, which propels the flying object 100.

The flying object 100 may be provided with a main body part that can contain a processing unit, battery, etc. to be loaded in the flight part, which is equipped with a motor, propeller, frame, etc. to generate lift and thrust. The main body part can optimize the shape of the flying object 100 in its attitude during cruising, which is expected to be maintained for a long time during the movement of the flying object 100, and increase the flight speed, thereby efficiently reducing the flight time.

The main body part should have an outer skin that is strong enough to withstand flight, takeoff and landing. For example, plastics and FRP are suitable materials for the outer skin because of their rigidity and waterproof properties. These materials may be the same material as the frame 120 (including arms) included in the flight part, or they may be different materials.

The motor mount, frame 120, and main body part of the flight part may comprise connected parts, or they may be molded as a single unit using a monocoque structure or integral molding. (For example, the motor mount and frame 120 can be molded as one piece, or the motor mount, frame 120, and main body part can all be molded as one piece, etc.). By integrating the parts as one piece, the joints between each part can be made smooth, which is expected to have the effect of reducing drag and improving fuel efficiency of flying objects such as blended wing bodies and lifting bodies.

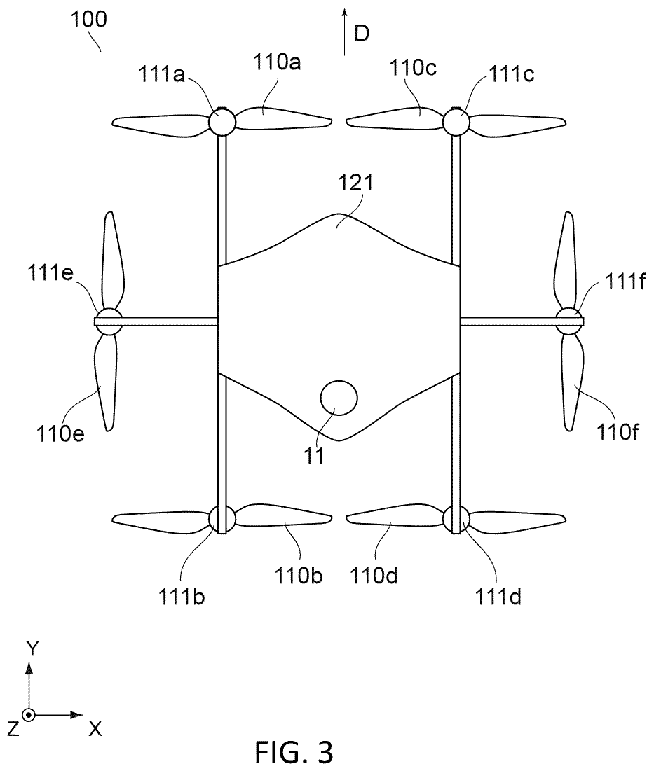

The shape of the flying object 100 may be directional, as illustrated in FIG. 1-FIG. 5. For example, the flying object 100 may have a streamlined main body part with low drag in a cruising attitude in no wind, or other shapes that improve flight efficiency when the nose of the flying object is directly facing the wind.

The safety device 10 provided with the flying object 100 dampens the fall speed below the free-fall speed and mitigates the impact and damage of a fall or collision when the flying object is unable to continue safe flight due to a malfunction or external factors. The safety device 10 is equipped with a parachute, a bag containing a balloon or airbag, or a banded member such as a kite tail, which can reduce the falling speed of the flying object by increasing air resistance. The parachute 12 is mounted on the flying object in an undeployed state and can be ejected and deployed under predetermined control. The following describes a case in which the safety device 10 is equipped with the parachute 12. However, the safety device is not limited to this case, as long as it can obtain the effect of attenuating the falling speed of the flying object.

Deployment of the parachute 12 may be controlled by a terminal or control device operated by a person on the ground, which transmits a deployment control signal at an arbitrary timing and remotely controls the deployment. In some cases, flying objects that provide services such as delivery may fly outside the line of sight of humans by autonomous flight, or fly without remote control. The information acquired by the flying object from its on-board sensors or the results of processing the information may be used as a trigger to make control decisions for deployment. This makes it possible to have the deployment of the parachute 12 be performed automatically even when no human is monitoring the state of the flying object, such as when the flying object is flying autonomously.

The deployment of the parachute 12 can be performed using known technology such as springs, explosives, gas, etc. The safety device and flying object should be fixedly connected so that they cannot be unintentionally disconnected by the impact generated by the deployment of the parachute 12.

When the deployment control of the parachute 12 is performed automatically, it is conceivable to combine one or more pieces of information that can be used as triggers for deployment control. Examples are a downward acceleration (e.g., when the downward acceleration exceeds the reference acceleration), altitude of the flying object (e.g., when compared to a reference altitude, the result is below the reference altitude, etc.), vertical rotation of the flying object and horizontal rotation of the flying object (e.g., when the gyro sensor or accelerometer determines the direction or number of rotations of at least one of the vertical or horizontal directions of the flying object and indicates a direction of rotation outside the reference range, or when the reference number of rotations is exceeded), motor speed (e.g., when the number of revolutions in one or more motors provided by the flying object is below or above the reference speed), etc. However, it should be able to trigger an anomaly in a flying object that could lead to a crash, and is not limited to this. The trigger for automatic deployment control during autonomous flight control may be at least partially different from the trigger for automatic deployment control during manual flight control, such as a propo/radio. For example, when a flying object that normally performs autonomous flight control is switched to manual flight control, it may be switched to not determine the triggers related to the altitude of the flying object, for example, because irregular problems may cause it to land outside the flight path. Furthermore, even during autonomous flight control, at least some of the triggers for automatic deployment control may be different from those for cruising, for example, switching not to determine triggers related to the altitude of the flying object, especially when landing.

When deploying the parachute 12, a step to stop the rotation of the motor 111 and propeller 110 provided by the flying object may be provided before the parachute ejection step in order to prevent the deployed umbrella member 13 and line member 14 from unintentionally getting entangled.

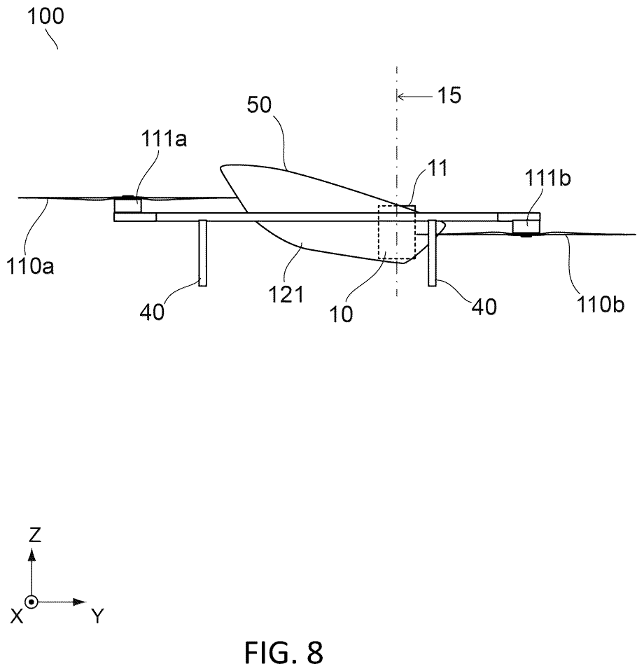

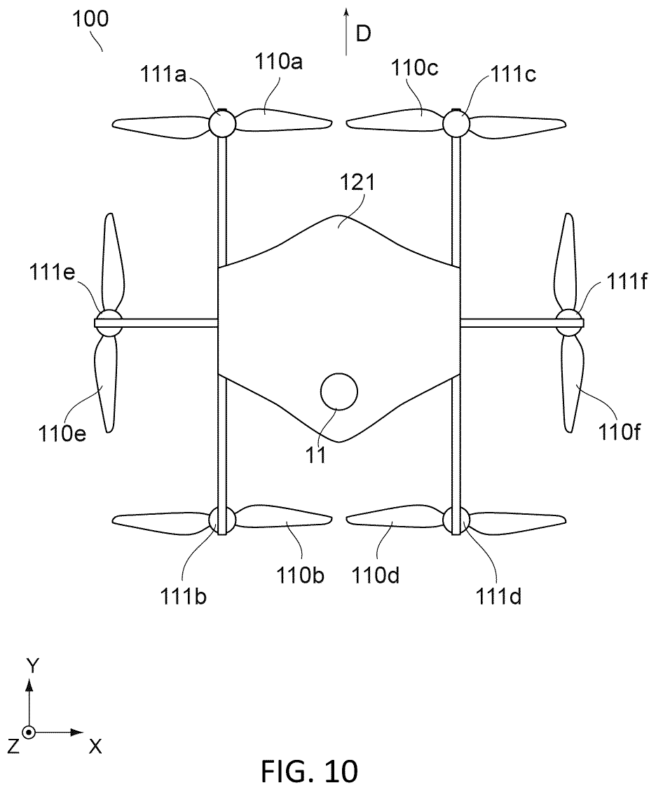

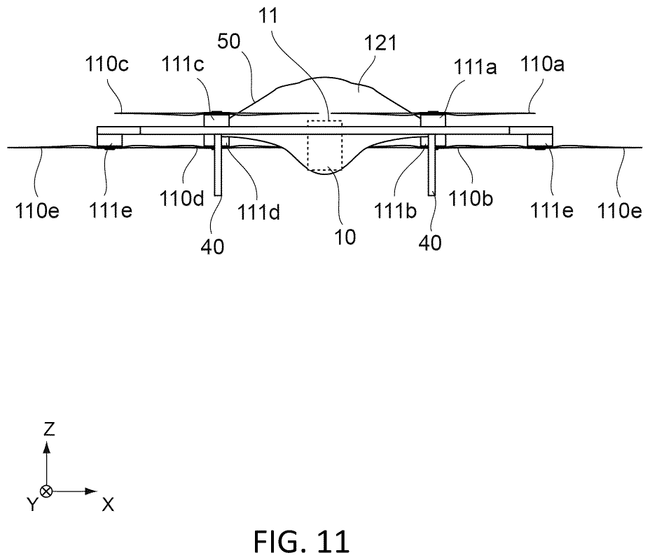

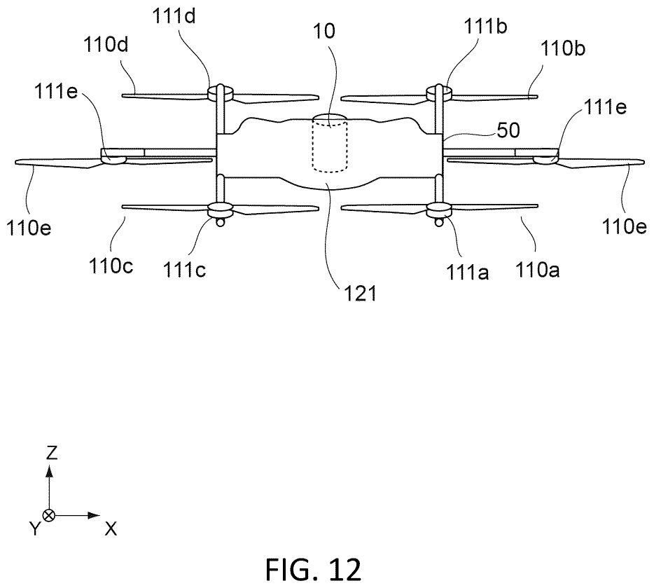

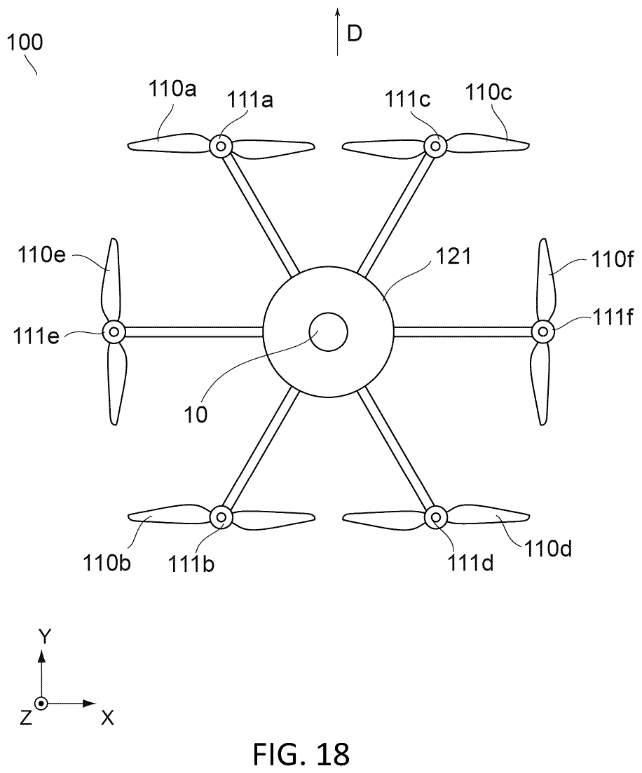

Furthermore, the safety device 10 should be provided in an unobstructed position for its deployment. In conventional flying objects, it is widely known that the safety device 10 is vertically installed or comprises the upper center of the flying object during hovering or landing, as shown in FIG. 8-FIG. 12 and FIG. 16-FIG. 19.

In such a configuration, even if the shape of the main body part of the flying object uses a shape with low drag in the cruising attitude, the drag may increase due to the mounting of the safety device 10. In this case, the flying object's flying efficiency will be greatly reduced.

In the flying object according to the present invention, the drag generated by the safety device 10 is configured to be smaller during cruising of the flying object 100 than during hovering or landing, thereby suppressing the decrease in flight efficiency during cruising.

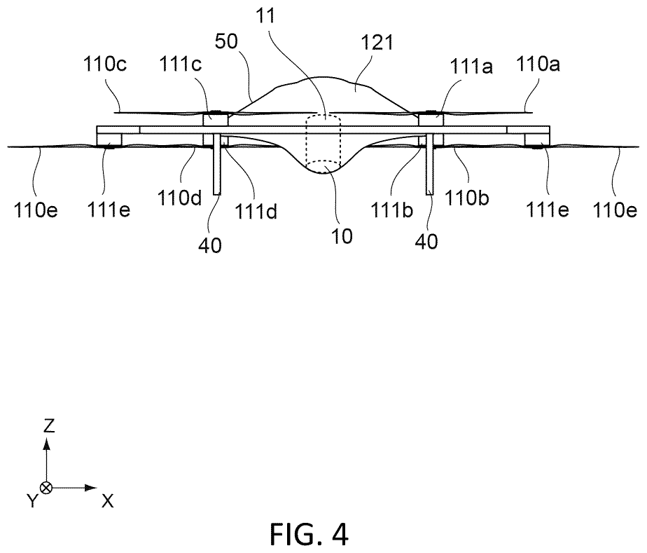

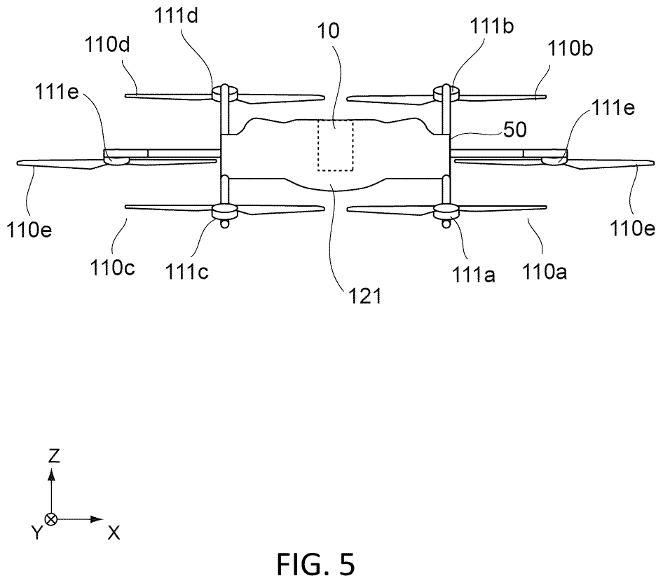

For example, as shown in FIG. 4 and FIG. 5, the projected area (i.e., front projected area) of the safety device 10 viewed from the direction of travel during cruising of the flying object is set so that the projected area is reduced compared to the attitude during hovering or landing, thereby reducing the drag force during cruising of the flying object and suppressing the decrease in flight efficiency.

As illustrated in FIG. 1, when the external shape of the safety device 10 is simple (e.g., cylindrical, rectangular, weight base, etc.) and the deployment of the safety device is performed from the top surface, a vertical centerline 15, which intersects an ejection part 11 of the safety device 10 substantially perpendicularly, may be provided so that the flying object 100 tilts in the direction opposite to the forward direction of the flying object 100 when hovering or landing (hereinafter referred to as the backward direction of the flying object). When the flying object 100 is in a cruising attitude, as illustrated in FIG. 2, the angle of inclination of the safety device 10 toward the flying object rearward (i.e., the central axis of the safety device is closer to the vertical direction) is reduced, at least compared to when hovering or landing.

The angle of inclination of the safety device 10 toward the rear of the flying object should be the same or approximate to the angle at which the flying object 100 is displaced from the landing or hovering attitude to the cruising attitude. For example, when the cruising attitude of the flying object 100 is a 20-degree forward tilt from the hovering or landing attitude, the safety device 10 should be installed at a 20-degree backward tilt to have the smallest projected area from the direction of the flying object's travel when the flying object is in cruising flight.

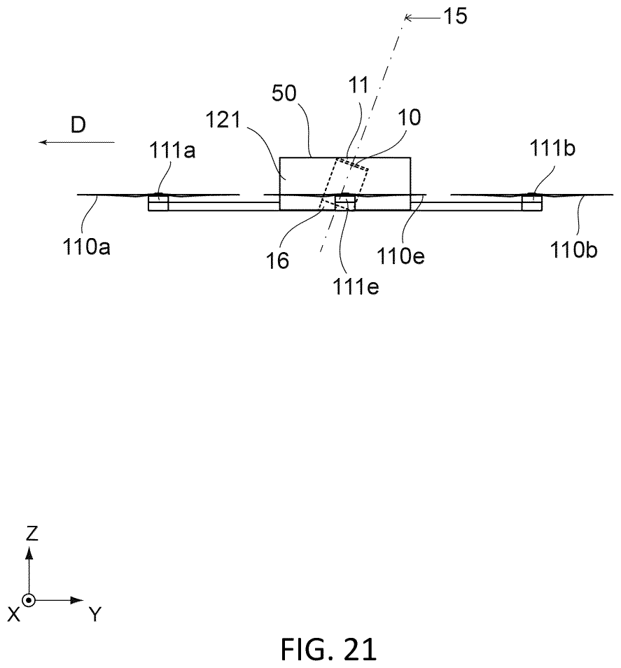

The safety device 10 may be installed to a safety device mounting part (including, for example, a sloping surface at a predetermined angle that the bottom of the safety device 10 contacts or a support member that supports the safety device 10 at a predetermined angle) provided on the flying object in advance so that it will be at a predetermined angle when connected. The connection may also be made to a surface with an inclination different from the predetermined angle (e.g., a horizontal surface), as illustrated in FIG. 21, using a connection member 16 (a safety device mounting part that can be installed later) that is inclined at a predetermined angle for connection to the surface. A flight object that is designed to be connected to a safety device will be provided with a safety device mounting part that can be connected to the safety device at a predetermined angle in advance. However, when a flying object without a safety device mounting part or a general-purpose flying object is used with a safety device connected to it, it may be difficult to adjust the angle at which the safety device is attached. By using a connection member 16 with a sloped surface so that the safety device to be connected is at a predetermined angle, it is possible to properly connect the safety device even to a flying object without a safety device mounting part. The connection member 16 should be strong enough to withstand the deployment of the safety device 10. For example, it may comprise the same material as the frame and cover of the flying object.

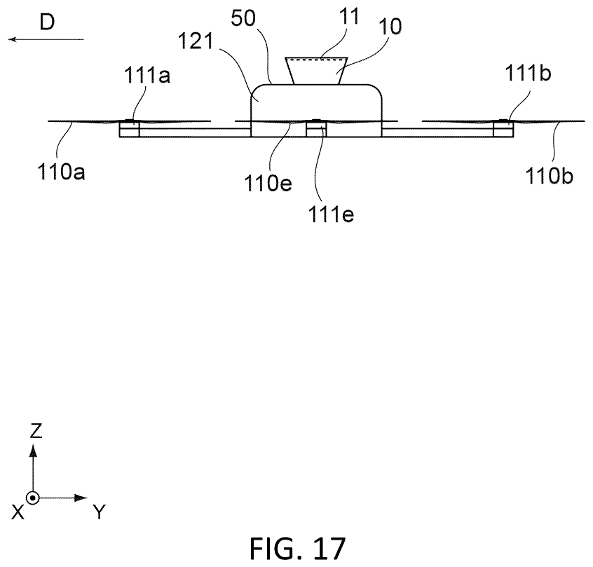

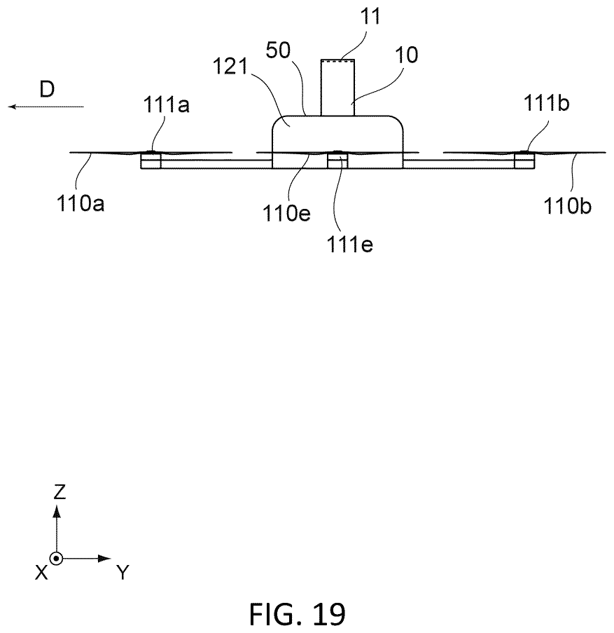

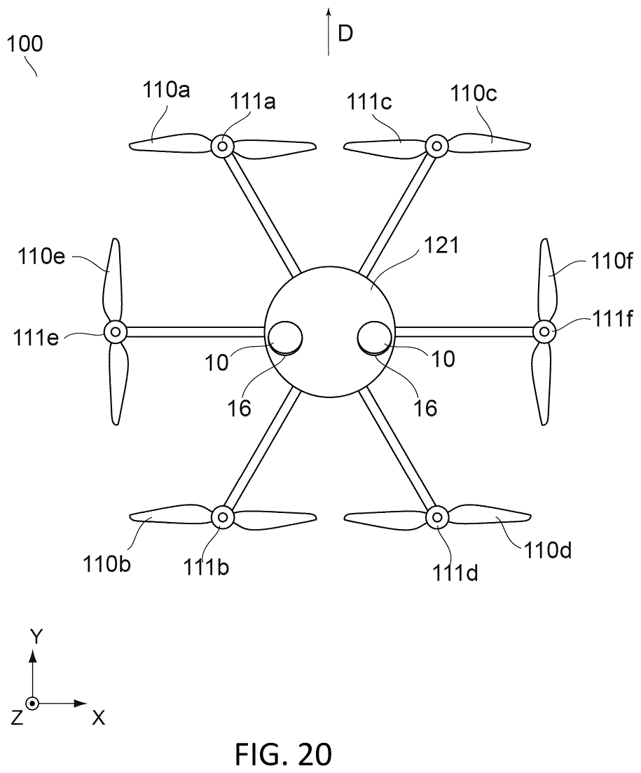

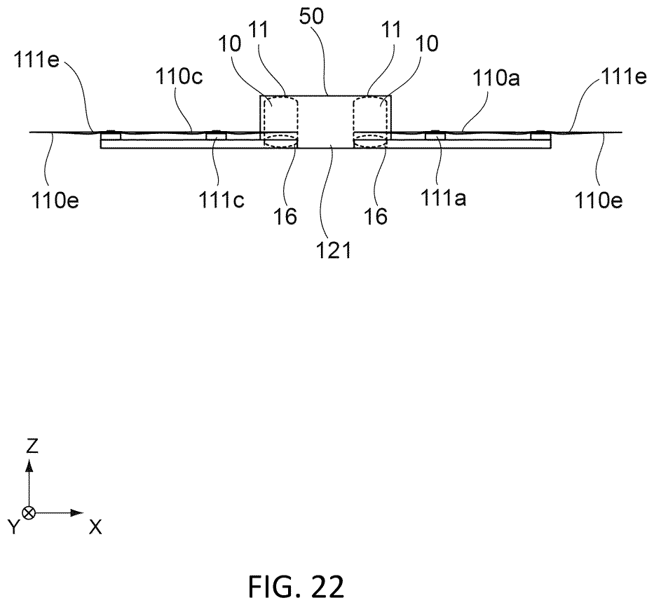

In existing flying objects and safety devices, the method of installing the safety device 10 on the outside of the cover of the main body part of the flying object is widely known, as shown in FIG. 17 and FIG. 19. In this case, the flight efficiency of flying objects with safety devices may deteriorate because it is difficult to give the safety device itself a shape that takes into account the aerodynamic characteristics of each flying object in accordance with its cruising attitude. As illustrated in FIG. 1 and FIGS. 20-22, by providing the safety device 10 so that it is partially or completely covered by the cover 50, the increase in drag of the flying object equipped with the safety device can be reduced.

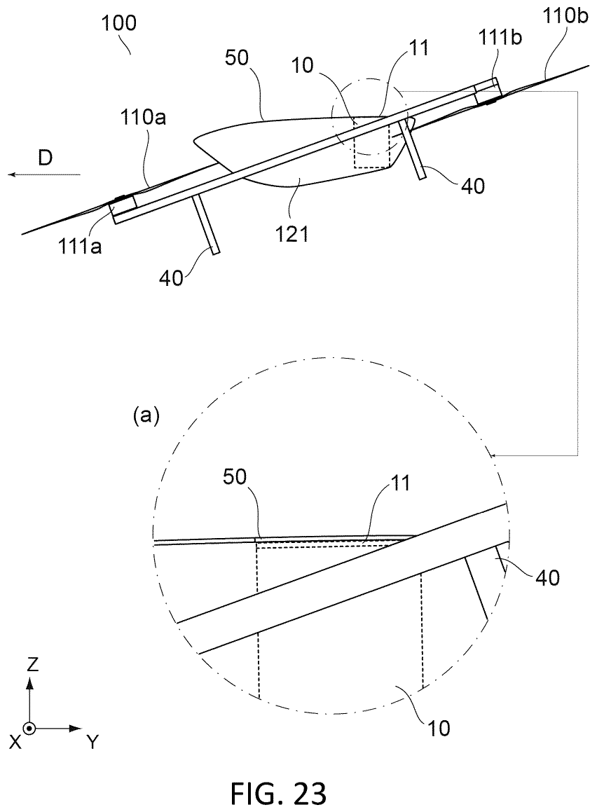

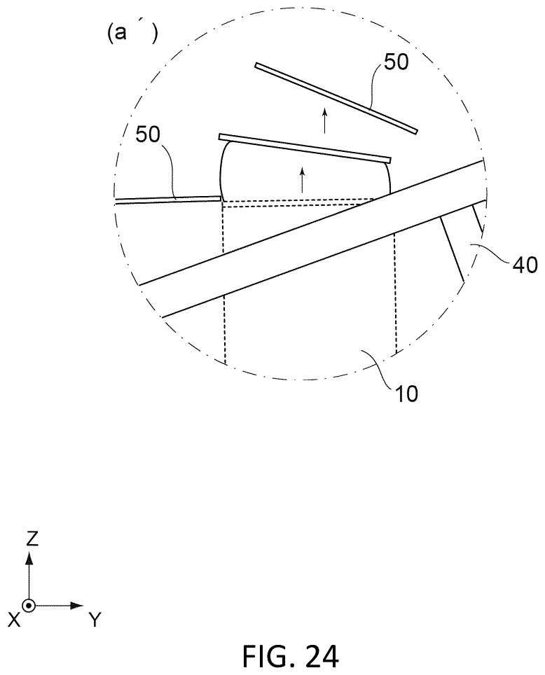

As illustrated in FIGS. 23 and 24, in a configuration in which the ejection part 11 of the safety device 10 is partially or fully covered by the cover 50, at least a part of the cover 50 should be provided so that it can be opened or dropped or damaged during deployment of the safety device so as not to interfere with the deployment of the safety device 10 (e.g., ejection of the parachute 12). This may be done by using the force during the deployment of the safety device (e.g., pressure from the parachute being ejected), or by providing a step to act on the cover 50 in advance before the deployment of the safety device. Also, although the waterproofing and dustproofing performance may be reduced, it is possible to comprise a configuration that does not hinder the deployment of the safety device 10 by pre-opening the cover 50 near the ejection part 11.

### Details of the Second Embodiment

In the details of the second embodiment of this invention, the components that overlap with those of the first embodiment operate in the same way, so the explanation will be omitted here to avoid repetition.

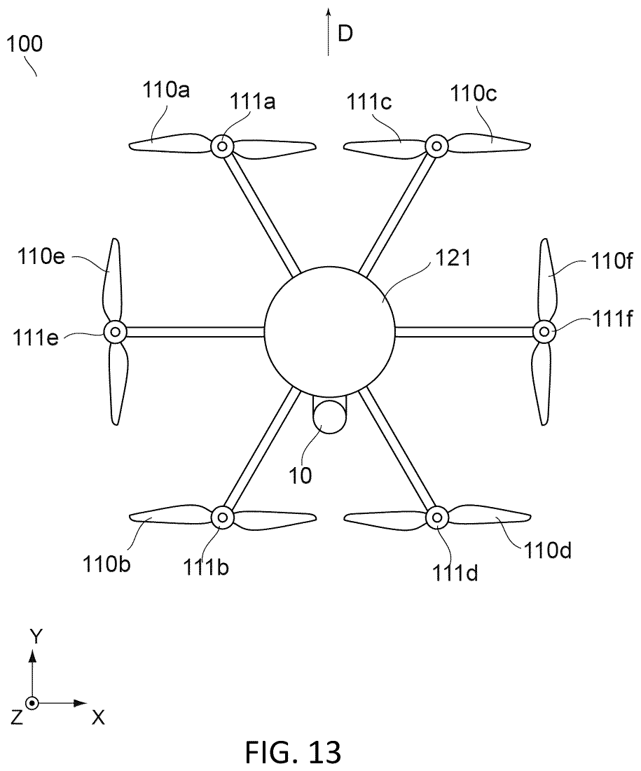

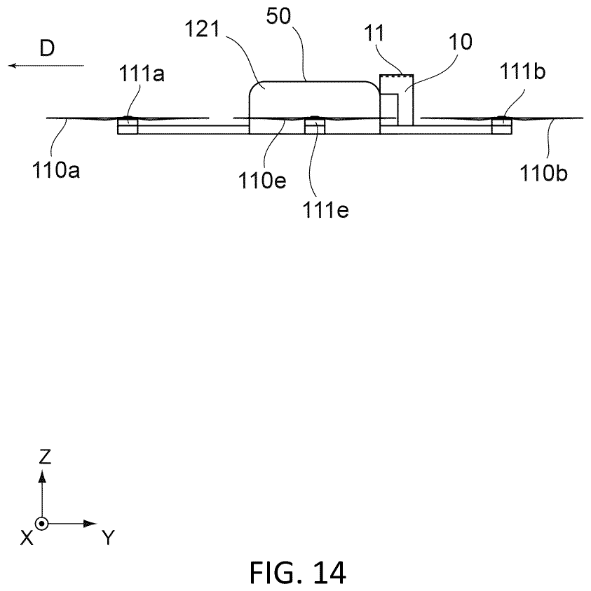

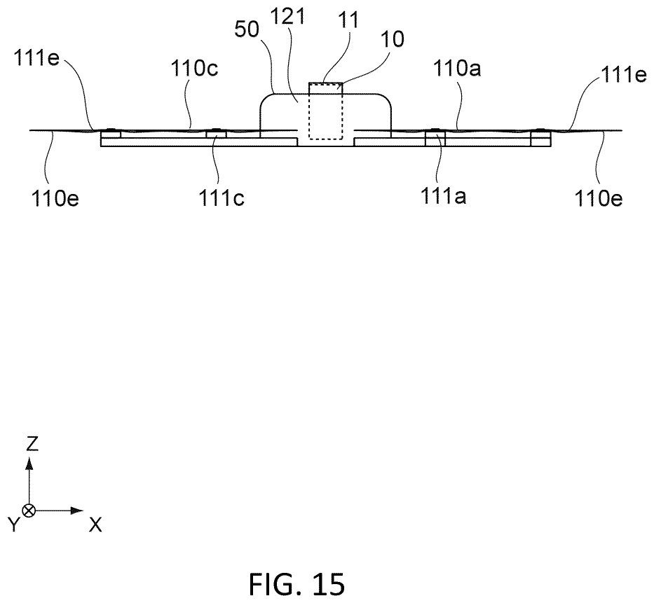

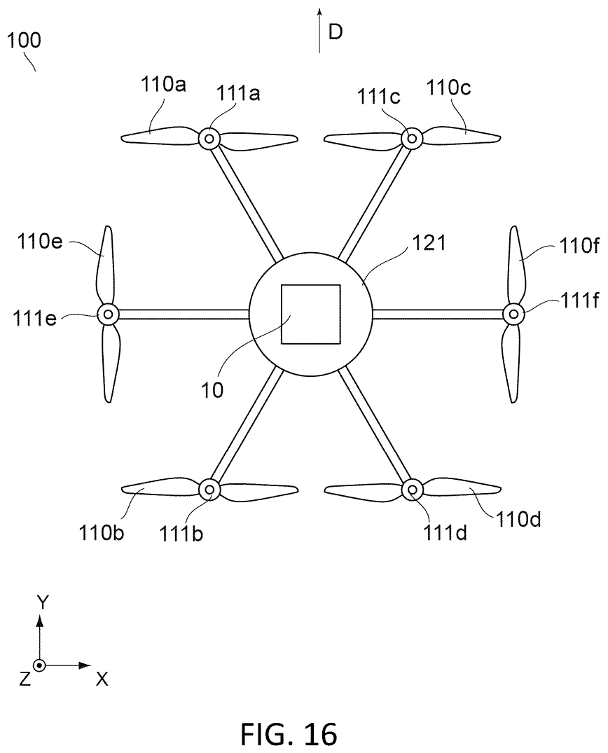

As illustrated in FIG. 13-FIG. 15, the safety device 10, viewed from the direction of travel of the flying object 100, may be installed so that it overlaps other components of the flying object (e.g., main body part, arm, cover, battery, etc.) when the flying object 100 is cruising or landing. Compared to the case shown in FIG. 16-FIG. 19, where the safety device 10 is installed in the upper center of the flying object, the increase in drag during hovering and cruising is suppressed.

The location of the safety device 10 is, for example, where the center of the safety device 10 is offset rearward, forward, or to the side from the center of the flying object 100. By installing the safety device 10 in a position where the projected area of the flying object 100, as viewed from the direction of travel when the flying object 100 is in a cruising attitude, is not increased by the installation of the safety device 10 or the increase is suppressed by the installation of the safety device 10, the increase in drag force can be suppressed. Since a control part, a battery, a payload, etc. are generally installed in the center of the flying object, installing the safety device 10 at the rear of the flying object effectively suppresses the increase in drag force because the safety device will be behind them when the flying object 100 is in cruise.

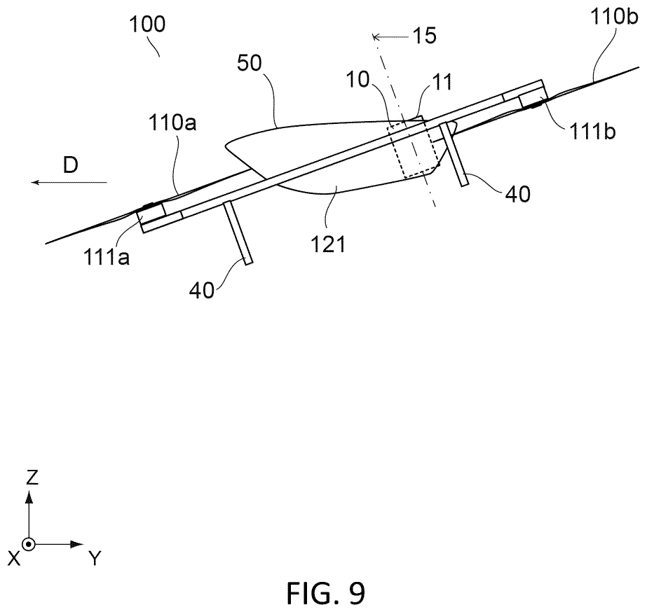

As illustrated in FIG. 9 and FIG. 23, in a configuration where the ejection part 11 of the safety device 10 is partially or completely covered by a cover 50, when the cover 50 provided by the flying object 100 is shaped like an inverted wing in order to reduce the generation of drag and lift during cruise, the safety device 10 is provided in such a way that its projected area is reduced during cruise, thereby reducing the undulation of the top surface of the cover. For example, in the flying object shown in FIG. 9, when a cover is provided over the safety device 10, undulations are generated above the cover at the rear of the flying object, leading to increased drag and lift in cruising attitude. In the case where the safety device 10 is provided behind the center of the flying object 100, as illustrated in FIG. 2, the thickness of the rear of the cover 50 can be reduced, making it possible to create a suitable shape in the streamlining of the rear end of the cover 50.

Autonomously controlled flying objects have recently been considered and implemented for use in various industries (e.g., inspection, survey, photography, surveillance, agriculture, disaster prevention, etc.). It is expected that by providing safety devices while preventing a reduction in flight efficiency, it will be possible to operate in environments where the aircraft will be above people and structures without deteriorating flight performance while improving the safety of people and objects in the vicinity.

The configurations of the flying body presented in each embodiment can be combined and implemented together to create a single design. It is desirable to comprise a suitable configuration in accordance with the cost of manufacturing the flying object and the environment and characteristics of the place where the flying object will be operated.

This embodiment described above is merely an example to facilitate understanding of the invention and is not intended to limit or interpret the invention. It goes without saying that the invention may be changed and improved without departing from its purpose, and that the invention includes equivalents thereof.

### DESCRIPTION OF REFERENCE NUMERALS

10 Safety device
11 Ejection part
12 Parachute
13 Umbrella member
14 Line member
15 Center line
16 Connection member
40 Landing legs
50 Cover
100 Flying object
110a-110f Propellers
111a-111f Motors
112 ESC
120 Flight part
121 Main body part
1000 Battery
1001 Flight controller
1002 Sensors
1003 Gimbal
1004 Transmission/reception unit
1006 Transceiver (radio)

1. A flying object provided with a safety device that attenuates the fall speed,
wherein the safety device is mounted at an angle at which the drag force is reduced when in traveling state rather than when in landing or hovering state.

2. The flying object according to claim 1,
wherein the safety device has a reduced frontal projected area when in traveling state than when in landing or hovering state.

3. The flying object according to claim 1,
wherein, in the landing or hovering state, the centerline of the safety device is inclined toward the rear of the flying object.

4. The flying object according to claim 3,
wherein the inclination angle of the centerline of the safety device is the same or similar in magnitude to the angle of forward inclination of the airframe when the flying object is in cruise attitude.

5. The flying object according to claim 1,
wherein the safety device contains a parachute within the safety device.

6. The flying object according to claim 1,
wherein, in the landing or hovering state, the center of the safety device is rearward of the center of the flying object.

7. The flying object according to claim 1,
wherein, in the landing or hovering state, the center of the safety device is forward of the center of the flying object.

8. The flying object according to claim 1,
wherein, in the landing or hovering state, the center of the safety device is lateral to the center of the flying object.

9. The flying object according to claim 1,
wherein the safety device is at least partially covered by a cover provided by the flying object.

10. The flying object according to claim 9, wherein the cover has a portion that is opened or detached when the safety device is deployed.

11. A safety device mounted on a flying object to attenuate the fall velocity of the flying object,
wherein the safety device is mounted at an angle at which the drag force is reduced with respect to the flying object in a traveling state rather than in a landing or hovering state.
